(19) United States
(12) Patent Application Publication
(10) Pub. No.: US 2022/0343247 A1
(43) Pub. Date: Oct. 27, 2022

(54) CONTROLLING RESOURCES BY FORECASTING A REQUIREMENT OF RESOURCES

(71) Applicant: AMADEUS S.A.S., Biot (FR)

(72) Inventors: Rodrigo ACUNA AGOST, Vallauris-Golfe Juan (FR); Thierry DELAHAYE, Nice (FR); Jorge DE ANTONIO DEL PECHO, Madrid (ES)

(21) Appl. No.: 17/723,015

(22) Filed: Apr. 18, 2022

(30) Foreign Application Priority Data
Apr. 21, 2021 (FR) FR2104130

(51) Int. Cl. G06Q 10/06; G06Q 10/04

(52) U.S. Cl. CPC G06Q 10/06315; G06Q 10/04

(57) ABSTRACT

A computer implemented method for controlling resources comprising is presented. The method comprises determining an evolution index for a second time period with respect to a first time period, determining a forecasting index for a first forecasting time period with respect to a starting forecasting time period by dividing the evolution index for the first forecasting time period with respect to the starting forecasting time period through the evolution index for a second forecasting time period with respect to the starting forecasting time period, determining at least one forecasting value of the requirement of the resources in a future time period by multiplying a starting value corresponding to the requirement for resources with the forecasting index for the future time period, and applying the at least one forecasting value to control the resources.

### FIELD OF THE INVENTION

The present invention generally relates to methods and systems for controlling resources by forecasting a requirement of the respective resources, in particular, by forecasting a requirement of resources based on historical and current data.

### BACKGROUND

In many areas, predicting a resource requirement and controlling the provision of the resources is difficult. If it is a matter of steady-state systems, in which no or only minor external influences are to be expected and/or in which the resource requirement shows a known development, there already exist practicable approaches in the state of the art. However, if unforeseen circumstances have disturbed a well-known system such that the previous predictions are useless, those existing approaches may no longer be sufficient.

### SUMMARY

The present invention presents a new approach for controlling resources by forecasting a future requirement of the resources based on historical and current data. The new approach is applicable to resources for which, prior to the time of provision, indications of a later requirement occur. The invention uses a historical development of the requirement of the resources and of the indications of the requirement and combined this historical development with the known current indications of a requirement of the resources in the future.

A first aspect of the present invention concerns a computer implemented method for controlling resources. The method comprises as a first step determining an evolution index for a second time period with respect to a first time period. The evolution index is determined by receiving current data, wherein the current data was recorded on the first time period and comprises information associated with a requirement of the resources in the second time period, wherein the first time period is chronologically before the second time period, and historical data, wherein the historical data was recorded on a third time period and comprises information associated with the requirement of the resources in a fourth time period, wherein the third time period is chronologically before the fourth time period, wherein the fourth time period corresponds to the second time period in a reference period and wherein the third time period corresponds to the first time period in the reference period. The evolution index is then calculated based on the current data and the historical data.

The method further comprises as a next step determining a forecasting index for a first forecasting time period with respect to a starting forecasting time period by dividing the evolution index for the first forecasting time period with respect to the starting forecasting time period through the evolution index for a second forecasting time period with respect to the starting forecasting time period, wherein the second forecasting time period is chronologically before the first forecasting time period. The following step of the method is determining at least one forecasting value of the requirement of the resources in a future time period by multiplying a starting value corresponding to the requirement for resources with the forecasting index for the future time period. Finally, the method comprises applying the at least one forecasting value to control the resources.

In an embodiment, the starting value is a currently measured or determined requirement of the resources. Alternatively, the starting value is a determined forecasting value of the requirement of the resources for a time period chronologically before the future time period.

In a further embodiment, the current data and the historical data each comprise values for at least two parameters and wherein the evolution index is calculated by determining an evolution function value for the at least two parameters and adding all evolution function values, wherein the evolution function values are each weighted by a weighting factor, wherein all weighting factors add up to I. In yet a further embodiment, the evolution function value is determined by dividing the parameter of the current data through the corresponding parameter of the historical data.

In other embodiments, the first forecasting time period and the second forecasting time period are subsequent time periods and/or the historical data is an averaged data of corresponding time periods in at least two reference periods.

In an embodiment, applying the at least one forecasting value to control the resources comprises at least one of presenting the determined forecasting values to a user on a visual output device and/or automatically adjusting the resources provided.

In additional embodiments, the time periods are days, weeks, or months, and that the reference period is a year. Alternatively, the time periods are seconds, minutes, or hours, and the reference period is a day.

One specific embodiment relates to flights as resources, wherein the information associated with the requirement of flights comprises data of scheduled flights, search data for flights, and/or booking data of flights.

One other specific embodiment relates to data transmission capacity as resources, wherein the information associated with the requirement of data transmission capacity comprises scheduled data transmission capacity, data of booked videocalls and/or data of requested videocalls.

A second aspect of the invention concerns a distributed system configured to control resources according to the method described herein. The system comprises a computing system, wherein the computing system is configured to perform the determination of the evolution index, the determination of the forecasting index, and the determination of the forecasting value, at least two database systems, wherein the at least two database system store the current data and the historical data, and a network, wherein the computing system and the at least two database systems are connected via the network.

A last aspect of the invention concerns a computer program for controlling resources comprising instructions for executing the method described herein, when said program is executed on a computing system.

### BRIEF DESCRIPTION OF THE DRAWINGS

The subsequent description of embodiments is based on the accompanying set of figures in which similar reference numerals refer to similar elements and messages and in which:

FIG. 1 is an overview of the distributed system in which the method may be applied;

FIG. 2 presents a flow chart of the basic steps of the method for controlling resources;

FIG. 3 is a flow chart of determining an evolution index,

FIG. 4 presents an example of a reference year and a current year, and

FIG. 5 shows a possible forecast visualisation.

### DETAILED DESCRIPTION

As already outlined at the outset, the methodologies described herein relate to methods and systems for controlling resources by forecasting a requirement of the respective resources.

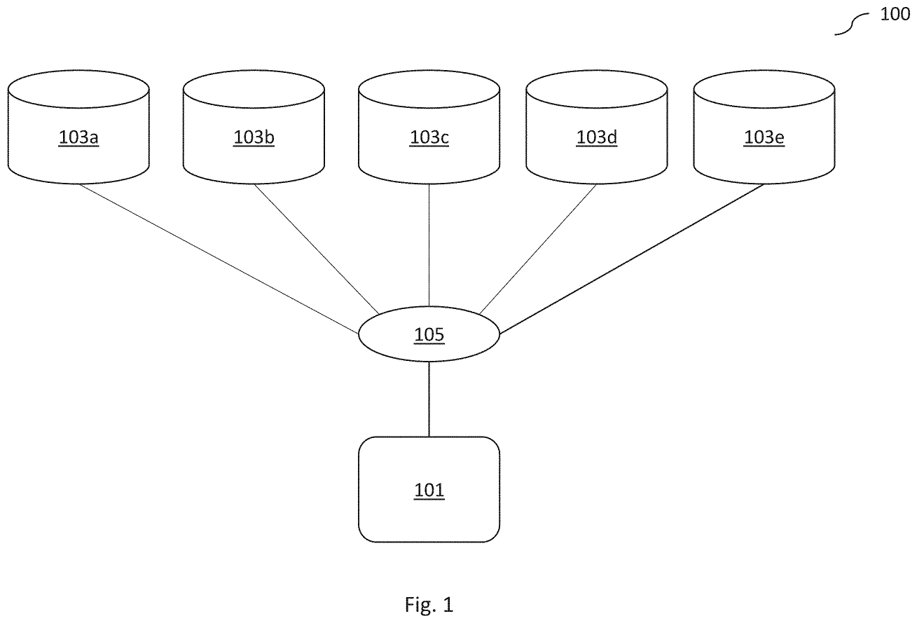

Now starting with FIG. 1, which depicts an overview of a distributed system 100 in which the method described herein may be implemented. The distributed system 100 comprises a computing system 101 and a plurality of database systems 103a, 103b, 103c, 103d, 103e. The computing system 101 is connected with the database systems 103 via a network 105.

The computing system 101 may be a single computer or server but may also consists of a plurality of interconnected servers or computers (not shown). The computing system 101 may include a processor, a memory, a mass storage memory device, an input/output (I/O) interface, and a Human Machine interface (HMI). The computing system 101 may also be operatively coupled to one or more external resources via a network or I/O interface. External resources may include, but are not limited to, servers, databases, mass storage devices, peripheral devices, cloud-based network services, or any other suitable computer resource that may be used by the computing system 101.

The communication system 101 may comprise a plurality of functional modules that fulfil different tasks described herein. The computing system 101 is at least configured to perform a determination of an evolution index, a determination of a forecasting index, and a determination of a forecasting value as described herein. The functional modules for the different deteiiiiination steps may be located in a single system but may also be distributed among a plurality of computing resources, e.g. over a plurality of servers.

Although FIG. 1 shows 6 database systems 103a, . . . , 103e, this is not limiting. There may be more or less database systems 103. In a preferred embodiment, there are at least two database systems 103. However, three, four, five, six or even more database systems 103 may be connected via the network with the computing system 101. The database systems may be hosted by third-parties or may be located within a local network of the computing system 101. The database systems 103 may be relational database systems, non-relational database systems or a mix of those database systems.

The database systems 103 store historical data and current data that is associated with the requirement of the resources. There may be one database storing the current data and another storing historical data. Alternatively, the data may be distributed over a plurality of database systems 103.The stored data may be recorded periodically or on demand. The data may be provided to the computing system 101 in response to a request or periodically.

The network 105 may be a wide area network, global network, the Internet, or similar network, may be a public or a private network, and/or may include multiple interconnected networks as known by the skilled person.

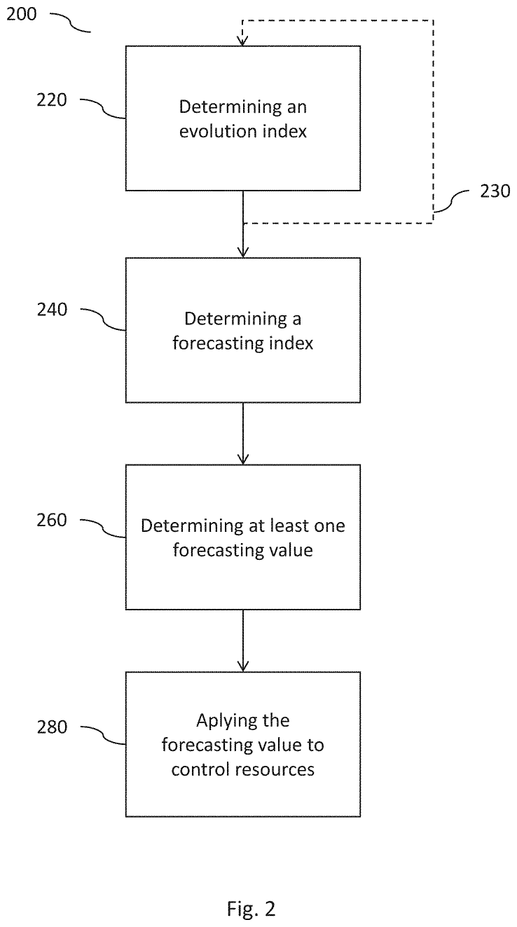

Now turning to FIG. 2 that shows a flowchart of the basic steps of the method described herein. The method 200 starts with determining an evolution index for a second time period (box 220). The second time period corresponds to a time for which the user wants to forecast a resource requirement. For example, the second time period may be the next week and the resources may be required flights from destination A to destination B during this week. In another example, the second time period may be today evening between 4 pm and 6 pm and the resources may be a required data transmission capacity during these hours.

For determining the evolution index, current data is received that was recorded on a first time period, which usually is a time period that has recently elapsed and for which data was recorded. For example, the first time period may be the last hour and the data of the first time period may consist of all data that was recorded in the last hour or recorded recently for the last hour.

The current data comprises information associated with a requirement of the resources in the second time period. For example, if the resources are flights, the current data may comprise data of scheduled flights for the second time period, search data for flights departing the second time period, and/or booking data of flights in the second time period. In another example, if the resources concem data transmission capacity, data may comprise scheduled data transmission capacity for the second time period, data of booked videocalls during the second time period, and/or data of requested videocalls, e.g., per mail, in the second time period. Hence, the current data comprises information that is associated with the requirement of the resources in the second time.

For determining the evolution index, not only current data is received but also historical data. The historical data was recorded on a third time period and comprises information associated with the requirement of the resources in a fourth time period, wherein the third time period is chronologically before the fourth time period. The historical data corresponds to the current data but for the past.

For example, the historical data may comprise, if the resources are flights, data of scheduled flights, search data for flights, and/or booking data of flight, wherein the data was recorded on the third time period and concerns flights in the fourth time period. In another example, if the resources concern data transmission capacity, historical data may comprise scheduled data transmission capacity, data of booked videocalls, and/or data of requested videocalls, wherein the data was recorded on the third time period and concerns data transmission capacity in the fourth time period.

It is important that the fourth time period corresponds to the second time period in a reference period and that the third time period corresponds to the first time period in the reference period. For example, if the first or current time period is week 11 of the year 2021 and the second time period is week 15 of the year 2021, the third time period could be week 11 of the year 2020 and the fourth time period would then be week 15 of the year 2020. The reference period would then be a year, and in particular the last year before the current year. This approach also takes seasonalities into account, i.e. that a requirement of resources depends on the season of a year.

However, the reference time period can also be the year 2019 or 2018 or any other preceding year. It is also possible to consider an average year, i.e. the historical data is then averaged data of a corresponding time period of an averaged reference period. For example, the third time period may be week 11 of years 2010-2019 and the data of these periods may then be averaged, which would also be done for week 15 of years 2010-2019. Other embodiments may use other aggregation techniques. For example, the historical data to determine the evolution index may also comprise maximum or minimum values or consider certain percentiles of a plurality of historical time periods.

The evolution index is then calculated based on the historical data and the current data and gives an information on how much the evolution of the first time period changed compared to the corresponding third time period in the past with focus on a future requirement of resources.

Next, a forecasting index for a first forecasting time period is determined (box 240). Two evolution indices are therefore required, hence the box 220 may be repeated (shown by dashed line 230). In particular, the calculation of the forecasting index comprises dividing the evolution index for the first forecasting time period through the evolution index for a second forecasting time period, wherein the second forecasting time period is chronologically before the first forecasting time period.

In an embodiment, the first forecasting time period and the second forecasting time period may be subsequent time periods. In another embodiment, there may be one or more intermediate or skipped time periods in between the first forecasting time period and the second forecasting time period. As will be understood by the person skilled in the art, the second forecasting time period may also be the current time period. The forecasting index represents the evolution between two time periods within a reference time period in view of the historical data.

The forecasting index is then used to determine at least one forecasting value (box 260) of the requirement of the resources in a future time period by multiplying a starting value corresponding to the requirement for resources with the forecasting index for the future time period.

For example, the starting value may be a measured current requirement of the resources. In an embodiment, in which the resources are flights and in which the method described herein is used to control the flights, e.g. the routes, the types of aircrafts, the number of seats per class, and the like, provided to the customers, e.g. to private people for holiday, to business people for business trips and/or to industry for cargo purposes, the starting value may be a current number of flights, capacity of flights or number of seats in flights provided. Alternatively, the starting number may be an index or rating value for the current state of the resources, i.e. the current resource requirements compared to previous time periods. For example, if the resources are flights, then the starting value may be a rating of how the current number of flights and/or a load factor of flights compare to the average of the last years, measured as a percentage. Or in another embodiment, if the resources are data transmission capacities of a large firm, the starting value may be the averaged utilized data transmission capacity on an average working day. Other applicable starting values that reflect the requirement of resources are also possible as will be understood be the person skilled in the art.

In another example, the starting value may also be a previous forecasting value, i.e. the starting value may be a determined forecasting value of the requirement of the resources for a time period chronologically before the future time period. That means, determining forecasting values can be made iteratively. For example, let it now be time t. The first forecasting value, f valueₜ₊₁, for the next time period t+1, is calculated by:

fvalueₜ₊₁=startₜ×findex_{t+t ,} Equation 1

wherein startₜ denotes the starting value of the current measured resources requirement and findexₜ₊₁ the forecasting index for time period t+1.

The forecasting index is thereby calculated by:

$${findex}_{t + 1} = \frac{{evindex}_{t + 1}}{{evindex}_{t}} \qquad Equation 2$$

wherein evindexₜ₊₁ the evolution index determined from historical data and current data for the time period t+1 with respect to the current, i.e., starting time period t and evindexₜ the evolution index determined from historical data and current data for the current time period t with respect to the current, i.e., starting time period t.

The forecasting value, fvalueₜ₊₂ for the subsequent time period t+2 is then determined with fvalueₜ₊₁ as starting value. This is shown by the following formula:

$${fvalue}_{t + 2} = {fvalue}_{t + 1} \times \frac{{evindex}_{t + 2}}{{evindex}_{t + 1}} . \qquad Equation 3$$

With the help of this iterative calculation, a forecasting value for each subsequent time period t+n can be calculated by:

$${fvalue}_{t + n} = {fvalue}_{t + n - 1} \times \frac{{evindex}_{t + n}}{{evindex}_{t + n - 1}} . \qquad Equation 4$$

Of course, it is also possible to skip time periods and/or calculate the forecasting value for time period t+n with starting value startₜ with this formula:

$${fvalue}_{t + n} = {start}_{t} \times \frac{{evindex}_{t + n}}{{evindex}_{t}} . \qquad Equation 5$$

The determined at least one forecasting value is then used to control the resources (box 280). For example, the determined at least one forecasting value may be presented to a user on a visual output device that controls the resources, e.g. who may additionally add further transmission capacities or schedule more flights. Additionally or alternatively, the forecasting values may be used to automatically adjust the resources provided.

For example, an adaption module in a computerised control system may compare the forecasting value with a threshold value and, in response to the forecasting value falling below or exceeding the threshold value, the adaption module may add or remove resources. Alternatively or additionally, the adaption could be a process that is triggered if the forecasting value exceeds the threshold value in a plurality previous time periods. Considering more time periods could be more robust, e.g., a single value may be a false alert, but ten consecutive high values may show a real change in the requirement of the resources.

In an embodiment, if the resources are data transmission capacities for videocalls made at a large firm, the adaption module may assign additional data transmission volumes and/or reserve additional virtual rooms if the forecasting value of a specific time period exceeds a threshold.

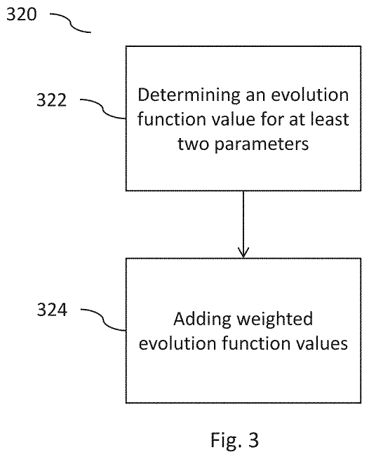

FIG. 3 presents a method 320 of how the evolution index may be determined when the historical data and the current data each comprise at least two parameters. At first, an evolution function value is determined for each of these at least two parameters (box 322).

For example, the evolution function value of a parameter may be determined by dividing the parameter of the current data through the parameter of the historical data. In an embodiment, in which the resources are flights and in which the information associated with the requirement of flights comprises data of scheduled flights, search data for flights, and/or booking data of flights, example parameters may be the number of scheduled flights, the number of searched flights and/or the number of booked flights.

In another embodiment, in which the resources are data transmission capacities and in which the information associated with the requirement of data transmission capacity comprises scheduled data transmission capacity, data of booked videocalls and/or data of requested videocalls, example parameters may be the amount of scheduled data transmission capacity, the number of booked videocalls and/or the number of requested videocalls.

After having determined the evolution function value for all parameters, the evolution index is calculated by adding all evolution function values, wherein the evolution function values are each weighted by a weighting factor, wherein all weighting factors add up to 1 (box 324). This results in the formula:

evindexₜ₊₁=Σα_{#}efuncv#_{t+1,t}, Equation 6

wherein efuncv#_{t+1,t} corresponds to the evolution function value for parameter #, with #=1 to n, for time period t+1 with respect to time period t and wherein Σα_{#}=1.

In an embodiment, the evolution function value is calculated by dividing the parameter of the current data through the corresponding parameter of the historical data. In an example with three parameters, this results in the following formula for time period t+1:

$${evindex}_{t + 1} = {α}_{1} \frac{pcurr {1}_{t + 1 , t}}{phist {1}_{t + 1 , t}} + {α}_{2} \frac{pcurr {2}_{t + 1 , t}}{phist {2}_{t + 1 , t}} + {α}_{3} \frac{pcurr {3}_{t + 1 , t}}{phist {3}_{t + 1 , t}} , \qquad Equation 7$$

wherein pcurr1_{t+1,t}, pcurr2_{t+1,t},pcurr3_{t+1,t} are the parameters of the current data, phist1_{t+1,t},phist_{2t+1,t},phist3_{t+1,t}, the corresponding parameters of the historical data, and α₁, α₂, α₃the corresponding weighting factors, with α₁+α₂+α₃ =1.

Additionally, an evolution function value for at least one parameter may be multiplied by an increasing factor. This is advantageous if the corresponding parameter has a greater influence on the evolution of the requirement of resources.

For example, if it is known that the booked flights have the highest influence on a requirement of flight resources, the evolution function value for the parameter corresponding to the number of flights booked until time period t and departing in time period t+1—e.g. calculated by dividing the number of flights booked until time period t and departing in time period t+1 for the current year by the corresponding time periods in the reference, e.g. historical time period— is multiplied by an increasing factor f.

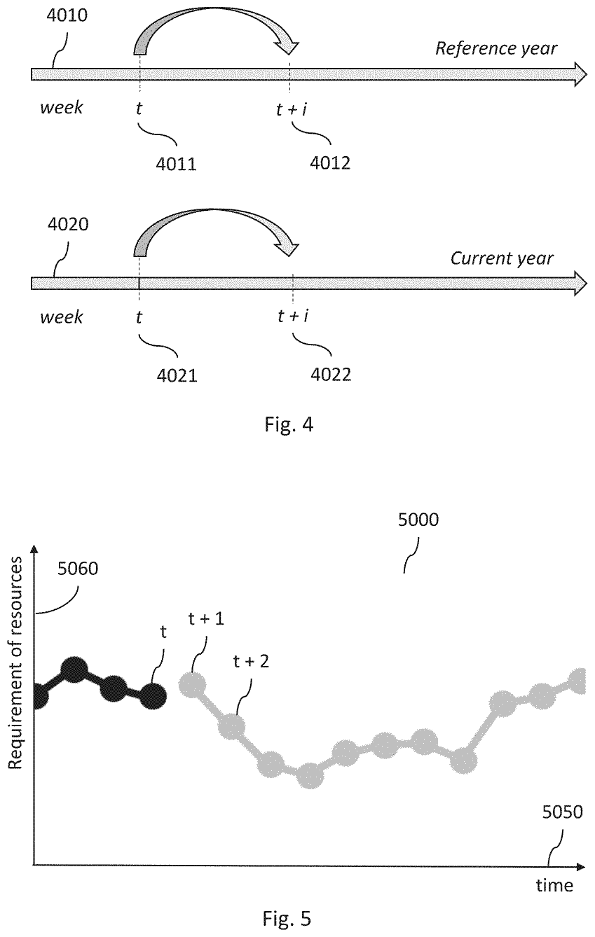

FIG. 4 shows an example of two time periods that correspond each to a year that each contain smaller time periods, such as weeks. The upper time period 4010 is the reference time period, i.e., for which historical data is available. The lower time period 4020 is the current time period, i.e., for which the forecast is required. Let's assume it is now week t 4021 in the current year and the resources requirement is to be forecasted for week t+i 4022 in order to control the resources provided in week t+i 4022. For the reference year, there is data available for corresponding time periods, i.e. for week t 4011 in the reference year with respect to week t+i 4012 in the reference year.

For example, if the resources are flights, the parameters of the historical and current data may comprise at least the following information. Current data may comprise data about future scheduled flights departing in week t+i as published in the current week t. The corresponding historical data may comprise data captured in week t of the reference year concerning scheduled flights departing in week t+i of the reference year.

Current data may also comprise data about the intensity of searches at current time t for trips in the future week t+i. The corresponding historical data may comprise data about the intensity at the same week t for departures in a corresponding week t+i of reference time period, i.e., the last year or the like.

In the same way current data and historical data may comprise information about bookings. For example, current data may comprise the number of bookings in week 35 in the year 2020 for trips in the future week 45 in 2020 and historical data may comprise the number of bookings in week 35 of the year 2019 for departure in week 45 of 2019. If the current number of bookings is 170 and the historical number of bookings is 2000, the corresponding evolution function value for the booking parameter, calculated by dividing the two values as described above, is:

$$efuncv \vert {bookings}_{45 , 35} = \frac{170}{2000} = 0.085 \qquad Equation 8$$

There may be a plurality of information on which the forecast is based, i.e., on which the evolution index is determined. Table 1 shows an example of values of parameters that may be considered if the resources are flights and if a forecast for week 45 of year 2020 should be determined based on data of week 35.

TABLE 1

| | # of | # of | # of | # of |
|---|---|---|---|---|
| | flight | scheduled | searches | hotels |
| for week 45 | bookings | flights | for flights | booked |
| week 35 - 2015 | 1500 | 150 | 15000 | 1000 |
| week 35 - 2016 | 1700 | 250 | 21000 | 1400 |
| week 35 - 2017 | 1600 | 250 | 19000 | 1300 |
| week 35 - 2018 | 1700 | 300 | 20000 | 1500 |
| week 35 - 2019 | 2000 | 350 | 25000 | 1800 |
| week 35 - 2020 | 170 | 20 | 5000 | 70 |

In an example, in which an averaged value of reference time periods, i.e., in this case reference years is considered, the historical data of 2015 to 2019 will be averaged. This results in the numbers shown in Table 2.

TABLE 2

| | # of | # of | # of | # of |
|---|---|---|---|---|
| | flight | scheduled | searches | hotels |
| for week 45 | bookings | flights | for flights | booked |
| historical data | 1700 | 260 | 20000 | 1400 |
| of week 35 | | | | |
| (averaged) | | | | |
| current data | 170 | 20 | 5000 | 70 |
| of week 35 | | | | |

In the above example, the corresponding weighting factors are:

α_{booking}=0.25, α_{scheduled}=0.25, α_{searches}=0.35αₕₒₜₑₗ=0.15, Equation 9

Then, the evolution index for week 45 based on week 35 is calculated by:

$${evindex}_{45} = 0.25 \frac{170}{1700} + 0.25 \frac{20}{260} + 0.35 \frac{5000}{20000} + 0.15 \frac{70}{1400} = 0.14 ( rounded ) \qquad Equation 10$$

If the forecasted value for week 44 is 20%, i.e. the requirement of flights is forecasted to be 20% of the corresponding week of a usual year, and if the evolution index of week 44 is 0.15, then, the forecasting value for week 45 is:

$${fvalue}_{45} = 20 \times \frac{0.14}{0.15} = 18.67 ( rounded )$$

Hence, in this example, the forecasting value for week 45 would be 18.67% of a requirement of flights of a usual past year.

FIG. 5 presents an embodiment that shows a forecast visualisation 5000 that can be used to control the resources. For example, a user may be presented, e.g. on a visual output device, with the forecast visualisation 5000 of the requirement of resources and the user may then adapt the provision of the resources in the future based on the forecast visualisation. The example forecast visualisation 5000 of FIG. 5 displays the development of time 5050 horizontally and the resource requirements 5060 vertically. Until the current time period t the chart is determined based on measured data (shown with black dots). From time t+1 on, the chart is based on forecasting values determined according to the method described herein (shown by grey dots).

Alternatively, the forecasted values can also be used to automatically adapt the provision of the resources. For example, if the resources concern data transmission capacity and the forecast is based at least on scheduled videocalls, the provided data transmission capacity for a specific time period, in which it is likely that there will be a higher requirement for data transmission, will be increased. Therefore, the computing system 101 of the distributed system 100 may additionally comprise an adaption module as described above. The adaption module may take the forecasted values into account, determine whether to adapt the resources and adapt the resources accordingly.

In another embodiment, a computer program comprising instructions is provided. These instructions, when the program is executed by a computer, cause the computer to carry out the resources controlling and forecast calculating as described herein. The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments described herein.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer.

A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

It should be appreciated that while particular embodiments and variations have been described herein, further modifications and alternatives will be apparent to persons skilled in the relevant arts. In particular, the examples are offered by way of illustrating the principles, and to provide a number of specific methods and arrangements for putting those principles into effect.

Accordingly, the described embodiments should be understood as being provided by way of example, for the purpose of teaching the general features and principles, but should not be understood as limiting the scope, which is as defined in the appended claims.

What is claimed is:

1. A method for controlling resources comprising:
determining an evolution index for a second time period with respect to a first time period by:
(i) receiving current data, wherein the current data was recorded on a first time period and comprises information associated with a requirement of the resources in the second time period, wherein the first time period is chronologically before the second time period;
(ii) receiving historical data, wherein the historical data was recorded on a third time period and comprises information associated with the requirement of the resources in a fourth time period, wherein the third time period is chronologically before the fourth time period, wherein the fourth time period corresponds to the second time period in a reference period and wherein the third time period corresponds to the first time period in the reference period; and
(iii) calculating the evolution index based on the current data and the historical data;
determining a forecasting index for a first forecasting time period with respect to a starting forecasting time period by dividing the evolution index for the first forecasting time period with respect to the starting forecasting time period through the evolution index for a second forecasting time period with respect to the starting forecasting time period, wherein the second forecasting time period is chronologically before the first forecasting time period;
determining at least one forecasting value of the requirement of the resources in a future time period by multiplying a starting value corresponding to the requirement for resources with the forecasting index for the future time period; and
applying the at least one forecasting value to control the resources.

2. The method according to claim 1, wherein the starting value is a currently measured or determined requirement of the resources.

3. The method according to claim 1, wherein the starting value is a determined forecasting value of the requirement of the resources for a time period chronologically before the future time period.

4. The method according to claim 1, wherein the current data and the historical data each comprise values for at least two parameters and wherein the evolution index is calculated by:
determining an evolution function value for the at least two parameters; and
adding all evolution function values, wherein the evolution function values are each weighted by a weighting factor, wherein all weighting factors add up to 1.

5. The method according to claim 4, wherein the evolution function value is determined by dividing the parameter of the current data through the corresponding parameter of the historical data.

6. The method according to claim 4, wherein at least one evolution function value is multiplied with an increasing factor before adding all evolution function values.

7. The method according to claim 1, wherein the first forecasting time period and the second forecasting time period are subsequent time periods.

8. The method according to claim 1, wherein historical data is an averaged data of corresponding time periods in at least two reference periods.

9. The method according to claim 1, wherein applying the at least one forecasting value to control the resources comprises at least one of presenting the determined forecasting values to a user on a visual output device and/or automatically adjusting the resources provided.

10. The method according to claim 1, wherein the time periods are days, weeks, or months, and wherein the reference period is a year.

11. The method according to claim 1, wherein the time periods are seconds, minutes, or hours, and wherein the reference period is a day.

12. The method according to claim 1, wherein the resources concern flights, and wherein the information associated with the requirement of flights comprises data of scheduled flights, search data for flights, and/or booking data of flights.

13. The method according to claim 1, wherein the resources concern data transmission capacity, and wherein the information associated with the requirement of data transmission capacity comprises scheduled data transmission capacity, data of booked videocalls and/or data of requested videocalls.

14. A distributed system configured to control resources, the system comprising:
a computing system, wherein the computing system is configured to:
(a) in order to determine an evolution index for a second time period with respect to a first time period:
(i) receive current data, wherein the current data was recorded on a first time period and comprises information associated with a requirement of the resources in the second time period, wherein the first time period is chronologically before the second time period;
(ii) receive historical data, wherein the historical data was recorded on a third time period and comprises information associated with the requirement of the resources in a fourth time period, wherein the third time period is chronologically before the fourth time period, wherein the fourth time period corresponds to the second time period in a reference period and wherein the third time period corresponds to the first time period in the reference period; and
(iii) calculate the evolution index based on the current data and the historical data;
(b) determine a forecasting index for a first forecasting time period with respect to a starting forecasting time period by dividing the evolution index for the first forecasting time period with respect to the starting forecasting time period through the evolution index for a second forecasting time period with respect to the starting forecasting time period, wherein the second forecasting time period is chronologically before the first forecasting time period;
(c) determine at least one forecasting value of the requirement of the resources in a future time period by multiplying a starting value corresponding to the requirement for resources with the forecasting index for the future time period; and
(d) apply the at least one forecasting value to control the resources;
at least two database systems, wherein the at least two database system store the current data and the historical data; and
a network, wherein the computing system and the at least two database systems are connected via the network.

15. A computer program product for controlling resources comprising program code instructions stored on a computer readable medium, wherein the program code instructions cause a computing system to:
in order to determine an evolution index for a second time period with respect to a first time period:
(i) receive current data, wherein the current data was recorded on a first time period and comprises information associated with a requirement of the resources in the second time period, wherein the first time period is chronologically before the second time period;
(ii) receive historical data, wherein the historical data was recorded on a third time period and comprises information associated with the requirement of the resources in a fourth time period, wherein the third time period is chronologically before the fourth time period, wherein the fourth time period corresponds to the second time period in a reference period and wherein the third time period corresponds to the first time period in the reference period; and
(iii) calculate the evolution index based on the current data and the historical data;
determine a forecasting index for a first forecasting time period with respect to a starting forecasting time period by dividing the evolution index for the first forecasting time period with respect to the starting forecasting time period through the evolution index for a second forecasting time period with respect to the starting forecasting time period, wherein the second forecasting time period is chronologically before the first forecasting time period;
determine at least one forecasting value of the requirement of the resources in a future time period by multiplying a starting value corresponding to the requirement for resources with the forecasting index for the future time period; and
apply the at least one forecasting value to control the resources.
